(19) United States
(12) Patent Application Publication
(10) Pub. No.: US 2008/0098195 A1
(43) Pub. Date: Apr. 24, 2008

(54) Memory system including flash memory and mapping table management method

(76) Inventors: Won-Moon Cheon, Hwaseong-si (KR); Yang-Sup Lee, Chung-gu (KR)

Correspondence Address: VOLENTINE & WHITT PLLC, ONE FREEDOM SQUARE, 11951 FREEDOM DRIVE SUITE 1260, RESTON, VA, 20190, US

(21) Appl. No.: 11/637,792

(22) Filed: Dec. 13, 2006

(30) Foreign Application Priority Data
Oct. 19, 2006 (KR) 2006-101961

(51) Int. Cl. G06F 12/00

(52) U.S. Cl. 711/202; 711/103

(57) ABSTRACT

A memory system is disclosed with a file system; a flash translation layer (FTL) receiving a logical address from the file system and translating it into a physical address, and a flash memory receiving the physical address. The FTL includes flag information and offset information, the flag information indicating page order for a memory block in the flash memory is a wrap-around order and the offset information defining a starting page for the memory block.

### BACKGROUND OF THE INVENTION

1. Field of the Invention

The present invention relates to a memory system including flash memory. More particularly, the invention relates to a memory system and a related mapping table management method.

This U.S. non-provisional patent application claims priority under 35 U.S.C §119 to Korean Patent Application 2006-101961 filed Oct. 19, 2006, the subject matter of which is hereby incorporated by reference.

2. Description of the Related Art

Contemporary and emerging portable electronic devices, such as digital cameras, MP3 players, cellular phones, PDAs, etc., have made increasing use of non-volatile memory systems including flash memory. Flash memory devices are finding wider application within such host devices because of their relatively lower power consumption characteristics and higher integration density in addition to the non-volatile data storage characteristics. In multiple contemporary host devices, the increasing data storage capacity provided by flash memory devices allows memory systems including flash memory to replace hard disk drives (HDDs).

Conventional flash memory performs an erase-before-write operation, as required by its inherent performance capabilities. That is, assuming a write operation is being performed in relation to a data sector of 512 bytes, a block of data including this sector is first erased and then the write operation is carried out. Accordingly, the use of flash memory necessitates the accommodation of longer write cycles, as compared with common write cycles for HDDs. Additionally, flash memory cells suffer from a well understood operational intolerance to repeated erase operations. That is, the read/write performance of flash memory cells becomes fatigued and ultimately impaired following many erase operations. For this reason, it is necessary to, wherever possible, avoid the application of repeated erase operation to any given block of flash memory cells within a memory system.

The so-called Flash translation layer (FTL) is a form of specialty software used to mitigate the foregoing drawbacks of the flash memory and effectively manage a memory system including flash memory. As commonly implemented, the FTL receives a logical sector number (LSN) from a file system and then translates the received logical sector number into a physical sector number (PSN). The physical sector number (PSN) is the address that will actually be used to store data within the flash memory.

The FTL generally includes an address mapping table designed to facilitate this address conversion. The address mapping table may be stored in and accessed within a random access memory within the memory system. Logical addresses and corresponding physical addresses are correlated within the address mapping table. The size of the address mapping table is dependant on a defined mapping unit, and the use of one or more mapping methods used in accordance with the mapping unit.

Representative mapping methods include a page mapping method, a block mapping method, and a hybrid mapping method. In the case of a page mapping method, a mapping table is commonly page unit size. That is, a logical page of data addresses is converted into a corresponding physical page of data addresses. In the case of a block mapping method, a mapping table is commonly block unit size, while in a case of a hybrid mapping method, the mapping table may be either page unit or block unit size.

Generally speaking, one memory block consists of several ten or several hundred pages. Thus, the corresponding size of a mapping table as between a page mapping method and a block mapping method is considerable. While block mapping methods and page mapping methods require mapping tales of dramatically different sizes, block mapping method must also cope with a (large numbers) merge requirement necessitated by the relationship of a single designated page within a block.

In contrast, hybrid mapping methods typically use a page mapping method over a log block and a block mapping method over a data block. Since hybrid mapping methods incorporate mapping method types, their use makes it possible to reduce the size of a corresponding mapping table while avoiding (or reducing) the number of merge operations.

In this context, a log block functions as a kind of a write buffer. That is, during a write operation, page data to be stored in designated data block is first stored in the log block. Page data in the log block and page data in the data block (hereinafter, referred to as an “old data block”) corresponding to the log block are stored in a new data block through a merge operation. After the merge operation, the log and data blocks are erased.

Hybrid mapping methods necessitate many page-copy and block-erase operations. For example, assuming that one block consists of four pages, four page-copy operations and two block-erase operations are required. Thus, the use of a hybrid mapping method and its attendant page-copy and block-erase operations may actually cause a decrease in the overall performance of a memory system incorporating same.

An improved memory system and a mapping table management method capable of reducing unnecessary page-copy and block-erase operations is required.

### SUMMARY OF THE INVENTION

In one embodiment, the invention provides a memory system comprising; a file system, a flash translation layer (FTL) which receives a logical address from the file system and translates the received logical address into a physical address, and a flash memory comprising at least one memory block and receiving the physical address, wherein the FTL includes flag information and offset information, the flag information indicating that page order in the memory block is a wrap-around order, and the offset information defining a starting page for the memory block.

In another embodiment, the invention provides a mapping table management method for a memory system which comprises; a file system, a flash translation layer (FTL) which receives a logical address from the file system and translates the logical address into a physical address, and a flash memory which receives the physical address, the mapping table management method comprising; searching the physical address in relation to the logical address, determining whether page order for a memory block associated with the physical address is a wrap-around order, searching a starting page for the memory block when the page order of the memory block is a wrap-around order, and reading a page based in the memory block in relation to the starting page.

### BRIEF DESCRIPTION OF THE DRAWINGS

FIG. (FIG.) 1 is a block diagram showing hardware architecture for a memory system incorporating conventional flash memory.

FIG. 2 is a block diagram showing a software structure for the memory system of FIG. 1.

FIG. 3 is a block diagram showing a memory system performing a conventional hybrid mapping method.

FIG. 4 is a diagram describing an exemplary hybrid mapping method for the memory system of FIG. 3.

FIG. 5 is a block diagram of a memory system according to an embodiment of the invention.

FIG. 6 is a diagram describing an exemplary mapping block management method for the memory system of FIG. 5.

FIG. 7 is a diagram describing an exemplary hybrid mapping method for the memory system of FIG. 5.

### DESCRIPTION OF EMBODIMENTS

Embodiments of the invention will now be described with reference to the accompanying drawings. This invention may, however, be embodied in many different forms and should not be construed as being limited to only the embodiments set forth herein. Rather, these embodiments are presented as teaching examples. Throughout the written description and drawings, like numbers refer to like or similar elements.

FIG. 1 is a block diagram showing a hardware architecture of a memory system using conventionally available flash memory. Referring to FIG. 1, a memory system 100 generally includes a central processing unit (CPU) 110, a random access memory (RAM) 120, and a flash memory 130. A Flash Translate Layer (FTL) used to perform an address mapping operation may be stored in RAM 120.

In one embodiment, flash memory 130 is a NAND flash memory consisting of a plurality of memory cells arranged in an array of strings. The memory cell array of NAND flash memory 130 is assumed to be partitioned into a plurality of memory blocks, each including a plurality of pages. Each page includes data derived from a group of memory cells connected to a common word line.

NAND flash memory 130 is assumed to perform erase operations on a memory block unit basis, and read/write operations on a page unit basis. Further, it is assumed that NAND flash memory 130 does not support overwrite operations, unlike other semiconductor memory devices. For this reason, NAND flash memory 130 must perform an erase operation before each write operation.

In order to use NAND flash memory 130 in a manner allowing its replace of a hard disk drive and in view of the foregoing performance assumptions, NAND flash memory 130 requires some form of memory management with respect to read, write and erase operations. The provided FTL is used, wholly or in part, to provide a memory management capability.

NAND flash memory 130 is further assumed to include designated data, log, and meta regions. The data region consists of a plurality of data blocks designated to store user data. The log region consists of one or more log blocks, each of which is assigned to a given data block.

When data is to be stored in a given data block it is not written directly to this data block. Instead, the data is written to a corresponding log block. Afterwards, by means of a merge operation, valid data pages stored in the log block and the data block are copied to a new data block. The merge operation thus causes a change in mapping information which may be stored in the meta region.

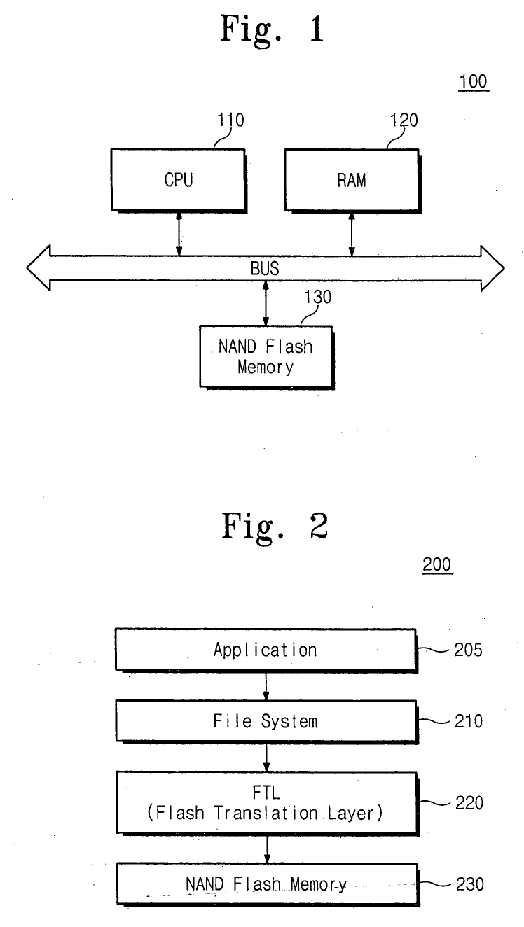

FIG. 2 is a block diagram showing a software structure (i.e., a set of relationships between various programs running on or in relation to a host device). One or more of these programs may be run in relation to a memory system like the one indicated in FIG. 1. Referring to FIG. 2, the FTL 220 receives a logical address from an application 205 or a file system 210, converts it into a physical address, and subsequently provides it to NAND flash memory 230. Here, application 205 and file system 210 are shown in a hierarchical relationship, but in other embodiments these two programs may be run at the same system level and independently communicate data to the FTL 220.

In the illustrated embodiment, a mapping table used for address conversion is stored in RAM 120. Mapping methods may be discriminated based on mapping units. For example, mapping methods include a page mapping method of performing a mapping operation on a page unit basis, a block mapping method of performing a mapping operation on a block unit basis, and a hybrid mapping method using both page and block mapping methods.

One potential drawback to the use of the page mapping method is that more memory space is required for the page mapping table. However, one drawback to the use of the block mapping method is the requirement of a large number of merge operations. In contrast, the hybrid mapping method uses the page mapping method over a log block. As the hybrid mapping method uses both page and block mapping methods, it is possible to reduce the overall size of a competent mapping table while also reducing the number of required merge operations.

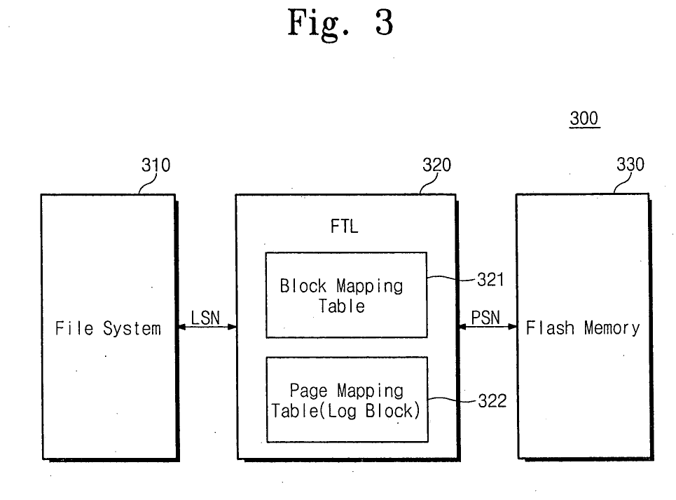

FIG. 3 is a block diagram showing a general memory system adapted to implement a hybrid mapping method. Referring to FIG. 3, a memory system 300 includes a file system 310, a flash translation layer (FTL) 320, and a flash memory 330.

FTL 320 receives a logical sector number (LSN) from file system 310 and translates the LSN into a physical sector number (PSN) using a mapping table. FTL 320 then provides the PSN to flash memory 330.

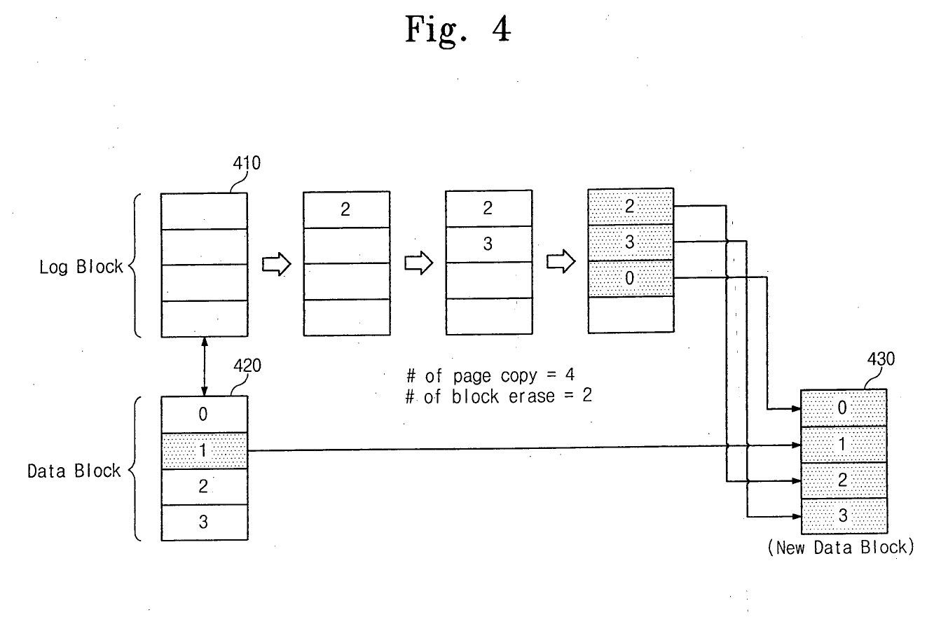

Referring to FIG. 3, FTL 320 includes a block mapping table 321 and a page mapping table 322. Herein, page mapping table 322 is used to map pages in a log block. A page write operation and a hybrid mapping operation of the log block will be more fully described with reference to FIG. 4.

FIG. 4 is a diagram describing an exemplary hybrid mapping method within a memory system such as the one illustrated in FIG. 3. In FIG. 4, it is assumed that each log block 410 and data block 420 consists of four pages and that log block 410 is assigned to data block 420.

Once a write operation is requested, FTL 320 determines whether there exists a log block 410 assigned to data block 420. If so, a page write operation is made over the assigned log block. If not, a new log block is assigned and a page write operation is made over the newly assigned log block.

Referring to FIGS. 3 and 4, file system 310 requests sequential write operations to logical addresses in an assumed order of “2, 3, 0, and 1”. Herein, it is assumed that logical page 1 is stored in a second physical page of data block 420.

Thus, it is assumed in the illustrated example that when a first write operation is requested to logic page 2, the write operation is carried out with respect to a first physical page of log block 410. Then when a second write operation is requested to logic page 3, a write operation is carried out with respect to a second physical page of log block 410. And then when a third write operation is requested to logic page 0, a write operation is carried out with respect to a third physical page of log block 410.

Under these conditions wherein log block 410 has a “free block” available and the overall log block requires additional space, FTL 320 may perform a merge operation. By means of this merge operation, logical pages 2, 3 and 0 stored in first through third physical pages of log block 410 are copy-combined within a new data block 430 with logical page 1.

Within this merge operation, logical page 0 in logic block 410 is copied to the first physical page of new data block 430. Next, logical page 1 in logic block 420 is copied to the second physical page of new data block 430. Logical pages 2 and 3 in logic block 410 are then copied to the third and fourth physical pages of new data block 430, respectively. Afterward the merge operation is complete, log block 410 and data block 420 may be erased and reallocated for subsequent use.

In accordance with the constituent hybrid mapping method, valid pages in log and data blocks 410 and 420 are copied to new data block 430 by means of the merge operation. First through fourth pages in new data block 430 are sequentially written with valid pages. An operation for sequentially writing pages in a block is referred to as an “in-place order”. On the other hand, an operation for randomly writing pages in a block is referred to as an “out-of-place order” or a “random-place order”.

If a write operation is sequentially directed to logical pages 0, 1, 2 and 3 in order, the logical pages are sequentially written in the corresponding first through fourth physical pages in log block 410. Pages written in log block 410 can be registered in a data block directly without an additional page copy operation. This is because pages are arranged so that log block 410 is suitable for the in-place order.

However, if a write operation is requested voluntarily, a page copy operation for rearranging page order is inevitably needed. Thus, assuming the example shown in FIG. 4, four page copy operations are required. After the page copy operations are performed, two erase operations are required to prepare the log and data blocks 410 and 420 for re-use.

As can be understood from the foregoing description, although the hybrid mapping method is used, a plurality of page copy operations are required to re-order pages. Further, after the page copy operations are completed, multiple erase operations are required.

Embodiments of the invention effectively address these drawbacks in the context of a hybrid mapping method. Embodiments of the invention reduce the number of required page copy operations and associated erase operations by treating a portion of the out-of-place order as an in-place order. The resulting decrease in the number of required page copy and block erase operations allows improvement in the performance of the overall memory system. One embodiment of a memory system using a hybrid mapping method according to the present invention will now be described in some additional detail.

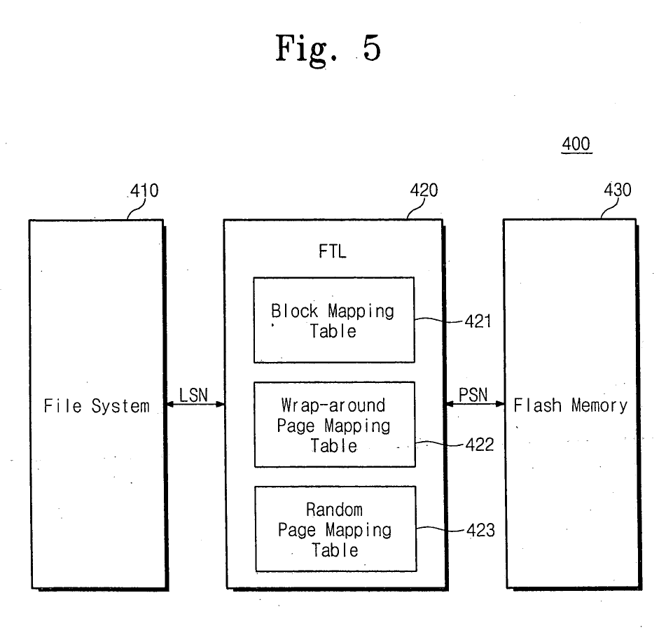

FIG. 5 is a block diagram showing a memory system according to an embodiment of the invention. Referring to FIG. 5, a memory system 400 includes a file system 410, a flash translation layer (FTL) 420, and a flash memory 430.

FTL 420 receives a logical sector number (LSN) from the file system 410 and converts it into a physical sector number (PSN) using a mapping table. FTL 420 then provides the PSN to flash memory 430.

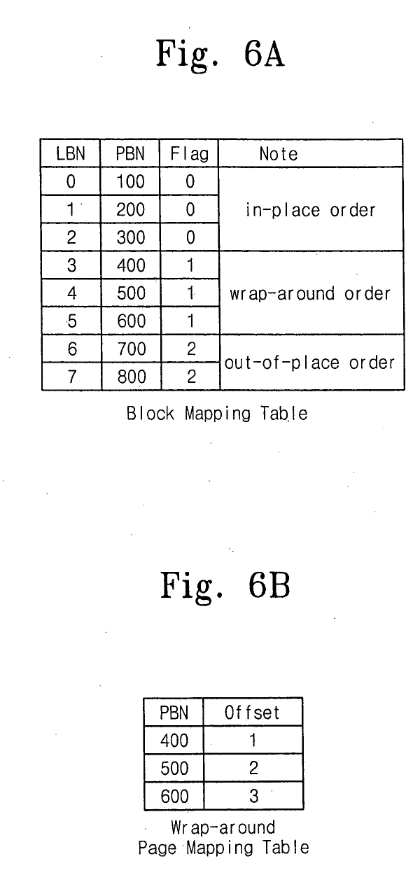

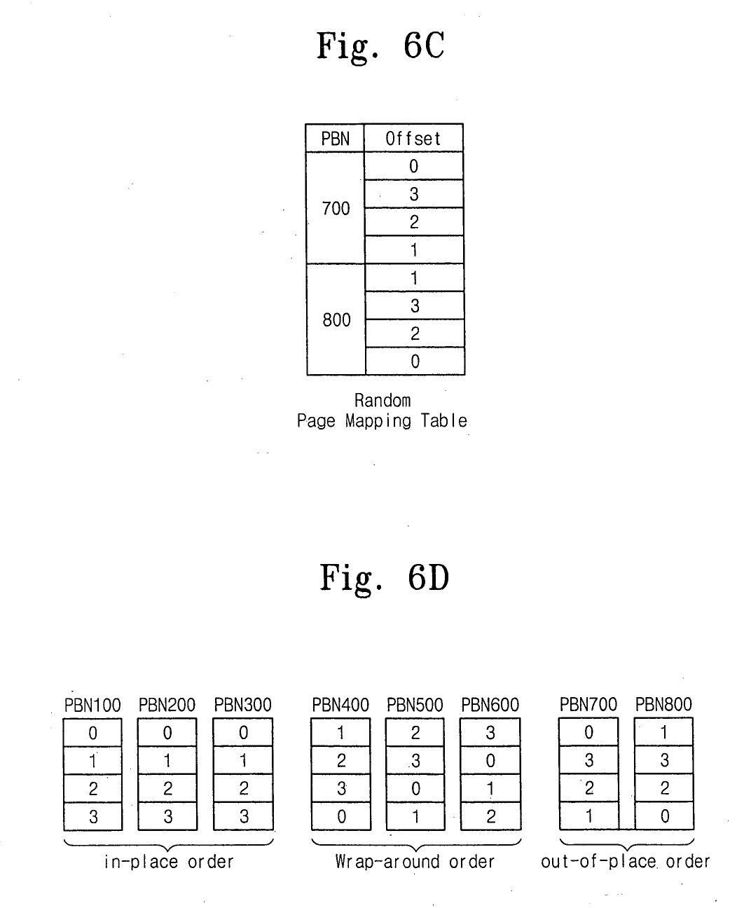

In the illustrated example, FTL 420 includes a block mapping table 421, a wrap-around page mapping table 422, and a random page mapping table 423. Random page mapping table 423 enables a page conversion operation in relation to an out-of-place order. Random page mapping table 423 will be more fully described with reference to FIG. 6.

Wrap-around page mapping table 422 enables a page translation operation in relation to a wrap-around order. The term “wrap-around order” denotes a page place order that is sequentially increased without necessarily using a starting page having a “0” value. For example, where one block consists of four pages, the following cases arise according to the wrap-around order:

Case 1: page ‘1’→page ‘2’→page ‘3’→page ‘0’

Case 2: page ‘2’→page ‘3’→page ‘0’→page ‘1’

Case 3: page ‘3’→page ‘0’→page ‘1’→page ‘2’

Like the in-place order, the wrap-around order supports sequential page write operations. However, in the case of a wrap-around order, the starting page need note be page ‘0’. The hybrid mapping method described in relation to FIGS. 3 and 4 may be identically executed to implement an out-of-place order even though the wrap-around order is used. That is, as illustrated in FIG. 4, four page copy operations and two block erase operations are required.

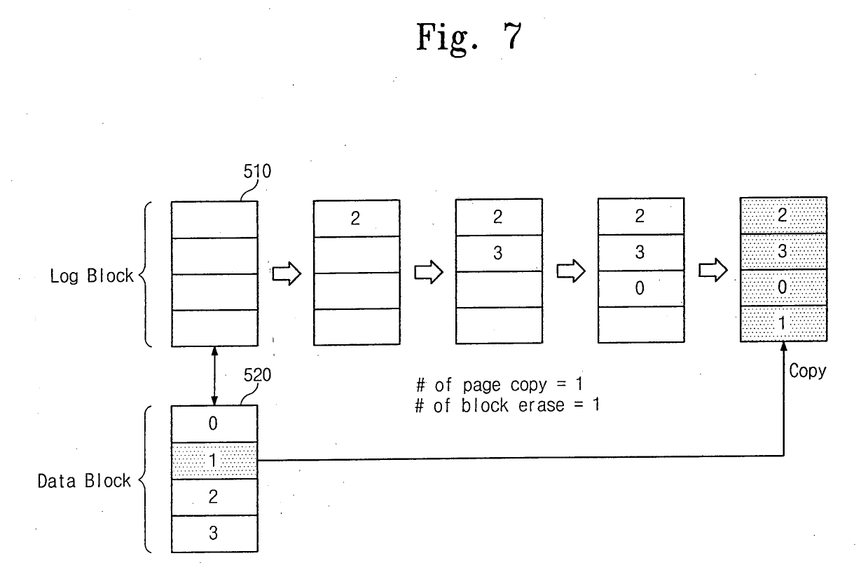

However, memory system 400 according to an embodiment of the invention includes wrap-around page mapping table 422 and processes a wrap-around order like the in-place order. As a result, this example requires only one page copy operation and one block erase operation, as will be more fully described with reference to FIG. 7.

Collectively FIGS. 6A through 6D are diagrams describing an exemplary mapping block management method for a memory system like the one illustrated in FIG. 5. FIG. 6A shows a block mapping table, FIG. 6B shows a wrap-around page mapping table, FIG. 6C shows a random mapping table, and FIG. 6D shows page places of a physical block.

Referring to FIG. 6A, a block mapping table includes a logical block number (LBN), a physical block number (PBN), and corresponding flag information.

A flag value of ‘0’ indicates an in-place order, a flag value of ‘1’ indicates a wrap-around order, and a flag value of ‘2’ indicates an out-of-place order. However, this is just one example of block mapping table information that may be used to identify particular page place orders.

Within this context, an in-place order having a starting page set to page ‘0’, does not necessitate the use of offset information. On the other hand, a wrap-around order necessitates the definition of a starting page, and an out-of-place order necessitates the definition of a page order.

FIG. 6B shows an exemplary wrap-around page mapping table. Referring to FIG. 6B, a physical block 400 has an offset value of ‘1’. This means that starting page for physical block 400 is set to a first page. A physical block 500 has an offset value of ‘2’. This means that a starting page for physical block 500 is set to a second page. A physical block 600 has an offset value of ‘3’. This means that a starting page for physical block 600 is set to a third page. Detailed page placement for physical blocks 400, 500 and 600 are illustrated in FIG. 6D.

FIG. 6C shows a random page mapping table in which a page order is defined according to an out-of-place order. Referring to FIG. 6C, a physical block 700 has offset information of 0, 3, 2 and 1. This means that No. 0, No. 3, No. 2, and No. 1 pages are written, respectively, to the first through fourth physical pages of physical block 700. A physical block 800 has offset information of 1, 2, 3 and 0. This means that No. 1, No. 2, No. 3, and No. 0 pages are written, respectively, to the first through fourth physical pages of physical block 800. Detailed page placements for physical blocks 700 and 800 are illustrated in FIG. 6D.

An exemplary sequence of page read operations will now be described with reference to FIGS. 6A through 6D.

The page read operation is first directed to page No. 2 in a block No. 1. The FTL searches physical block No. 200, which corresponds to logical block No. 1, by referencing a block mapping table. The FTL identifies corresponding flag information by recourse to the block mapping table. As seen in FIG. 6A, the flag information corresponding to logic block No. 1 is ‘0’. This flag information indicates that physical block No. 200 includes pages arranged according to an in-place order. Accordingly, page No. 1 of physical block No. 200 is read.

A next page read operation is directed to page No. 2 of block No. 4. The FTL searches physical block No. 500 corresponding to logical block No. 4 with reference to the block mapping table. The FTL identifies flag information of ‘1’ corresponding to logic block No. 4. This flag information indicates that physical block No. 500 includes pages arranged according to a wrap-around order.

Therefore, the FTL refers to the wrap-around page mapping table of FIG. 6B. This table includes offset information corresponding to physical block No. 500 of ‘2’. Pages in physical block No. 500 are arranged in the order 2, 3, 0 and 1. Accordingly, page No. 3 in physical block No. 500 is read.

A next page read operation is directed to page No. 2 in block No. 6. The FTL searches physical block No. 700 corresponding to a logical block No. 6 with reference to the block mapping table. The FTL identifies flag information of ‘2’ corresponding to logic block No. 6. This flag information indicates that physical block No. 700 includes pages are arranged according to an out-of-place order.

Therefore, the FTL refers to the random page mapping table of FIG. 6C. The offset information for physical block No. 700 includes 0, 3, 2 and 1. Pages in physical block No. 700 are arranged in the order 0, 3, 2 and 1. Accordingly, page No. 3 in physical block No. 700 is read.

FIG. 6D illustrates page placement in relation to the respective physical blocks. Since physical blocks 100 through 300 have a flag value of 0, pages are arranged according to the in-place order. Since physical blocks 400 through 600 have a flag value of 1, pages are arranged according to the wrap-around order. Since physical blocks 700 and 800 have a flag value of 2, pages are arranged according to the out-of-place order.

FIG. 7 is a diagram further illustrating the exemplary hybrid mapping method for a memory system according to an embodiment of the invention, as illustrated in FIG. 5. According to a mapping method illustrated in FIG. 4, four page copy operations and two block erase operations are required. But, according to a mapping method illustrated in FIG. 7, only one page copy operation and one block erase operation are required.

As illustrated in FIG. 7, pages No. 2, No. 3 and No. 0 are written in the first through third physical pages of a log block 510, and a page No. 1 is written in the second physical page of a data block 520. Herein, if a page place order is in this order of 2, 3, 0 and 1, a wrap-around order is selected.

In the illustrated example, page No. 1 in the second physical page is copied to the fourth physical page of log block 510. Log block 510 is registered as a new data block. In this embodiment, log block 510 is registered as a new data block where a block mapping table has a flag value of 1 and a wrap-around page mapping table has an offset value of 2. Data block 520 is erased. Accordingly, memory system 400 illustrated in FIG. 4 performs only one page copy operation and one block erase operation.

Additionally, a memory system according to an embodiment of the invention may include a random page mapping table when available memory space is insufficient. The memory system according to an embodiment of the invention processes the wrap-around order identically to the in-place order. Thus, within embodiments of the invention, it is possible to greatly reduce the number of required page copy and block erase operations needed to accomplish a merge operation.

Since the present invention performs a read operation with reference to flag information and offset information, it is unnecessary to fit a page order as illustrated in FIG. 4.

Further, a block mapping table necessitates only a 2-bit memory space to store flag information, and a wrap-around page mapping table necessitates only a 1-bit or 2-bit memory space to store offset information. Accordingly, it is possible to reduce a page copy number and a block erase number without increasing of a memory space.

Although the present invention has been described in relation to certain embodiments illustrated in the accompanying drawings, it is not limited thereto. It will be apparent to those skilled in the art that various substitution, modifications and changes may be thereto without departing from the scope of the invention.

What is claimed is:

1. A memory system comprising:
a file system;
a flash translation layer (FTL) which receives a logical address from the file system and translates the received logical address into a physical address; and
a flash memory comprising at least one memory block and receiving the physical address,
wherein the FTL includes flag information and offset information, the flag information indicating that page order in the memory block is a wrap-around order, and the offset information defining a starting page for the memory block.

2. The memory system of claim 1, wherein the FTL comprises:
a block mapping table which converts the logical block address into the physical block address; and
a wrap-around page mapping table which stores the offset information.

3. The memory system of claim 2, wherein the block mapping table stores flag information associated with the memory block.

4. The memory system of claim 2, wherein the block mapping table includes first flag information indicating an in-place order, and second flag information indicating the wrap-around order.

5. The memory system of claim 4, wherein the block mapping table further comprises third flag information indicating an out-of-place order.

6. The memory system of claim 5, wherein the FTL further comprises a random page mapping table which stores offset information indicating the out-of-place order.

7. The memory system of claim 1, wherein the flash memory is a NAND flash memory.

8. A mapping table management method for a memory system which comprises; a file system, a flash translation layer (FTL) which receives a logical address from the file system and translates the logical address into a physical address, and a flash memory which receives the physical address, the mapping table management method comprising:
searching the physical address in relation to the logical address;
determining whether page order for a memory block associated with the physical address is a wrap-around order;
searching a starting page for the memory block when the page order of the memory block is a wrap-around order; and
reading a page based in the memory block in relation to the starting page.

9. The mapping table management method of claim 8, wherein the FTL comprises flag information and offset information, the flag information indicating that page order for the memory block is a wrap-around order and the offset information defining the starting page for the memory block.

10. The mapping table management method of claim 9, wherein the FTL comprises:
a block mapping table which converts the logical block address into the physical block address; and
a wrap-around page mapping table which stores the offset information.

11. The mapping table management method of claim 10, wherein the block mapping table includes first flag information indicative of an in-place order; and second flag information indicative of the wrap-around order.

12. The mapping table management method of claim 8, further comprising reading a page when page order for the memory block is an in-place order.

13. The mapping table management method of claim 12, wherein the FTL comprises flag information indicative of the in-place order.

14. The mapping table management method of claim 13, wherein the FTL stores the flag information in a block mapping table.

15. The mapping table management method of claim 8, wherein the FTL comprises:
a block mapping table which converts the logical block address into the physical block address;
a wrap-around page mapping table which stores offset information defining the starting page of the memory block; and
a random page mapping table which stores offset information associated with an out-of-place order.

16. The mapping table management method of claim 15, wherein the block mapping table comprises first flag information indicative of the in-place order; second flag information indicative of the wrap-around order; and third flag information indicative of the out-of-place order.
